(19) United States
(12) Patent Application Publication
(10) Pub. No.: US 2011/0243383 A1
(43) Pub. Date: Oct. 6, 2011

(54) IMAGE PROCESSING DEVICE, IMAGE PROCESSING METHOD, AND PROGRAM

(76) Inventor: Hideki OYAIZU, Tokyo (JP)

(21) Appl. No.: 13/042,527

(22) Filed: Mar. 8, 2011

(30) Foreign Application Priority Data
Mar. 30, 2010 (JP) P2010-079184

(51) Int. Cl. G06K 9/00

(52) U.S. Cl. 382/103

(57) ABSTRACT

An image processing device includes a reference background storage unit that stores a reference background image, an estimation unit that detects an object from an input image and estimates an approximate position and an approximate shape of the object that is detected, a background difference image generation unit that generates a background difference image obtained based on a difference value between the input image and the reference background image, a failure determination unit that determines whether a failure occurs in the background difference image based on a comparison between the background difference image that is generated by the background difference image generation unit and the object that is estimated by the estimation unit, a failure type identification unit that identifies a type of the failure, and a background image update unit that updates the reference background image in a manner to correspond to the type of the failure.

### BACKGROUND OF THE INVENTION

1. Field of the Invention

The present invention relates to an image processing device, an image processing method, and a program. In particular, the present invention relates to an image processing device, an image processing method, and a program by which an object which is a foreground image can be accurately extracted from an input image.

2. Description of the Related Art

Techniques to extract an animal body region which is a foreground image and is an object from an input image which is picked up by a camera or the like are widely disseminated.

Among these techniques, background difference image generation processing is widely used as a method by which an animal body region can be simply and rapidly extracted. In the background difference image generation processing, a motionless reference background image is preliminarily picked up and a difference between the reference background image and an image which is picked up by a camera is obtained for every pixel so as to extract exclusively an animal body region.

Japanese Unexamined Patent Application Publication No. 63-187889 discloses such a technique that only a person existing at a near side from a image pickup position of a camera is extracted and an image generated by computer graphics (CG) or the like is synthesized with the background region so that when the person is displayed on a television telephone, the person can be exclusively displayed on a display unit of the television telephone without showing his or her living environment which is the background of the person, for example.

In more detail, a difference calculation unit 1 calculates a difference between a pixel value of a pixel of a reference background image f1 which is preliminarily picked up and a pixel value of a pixel of an image f2 which is picked up subsequently for each pixel, as shown in FIG. 1. Then, when a difference value is smaller than a predetermined threshold value, the difference calculation unit 1 sets a pixel value to zero, that is, the background is deleted so as to generate a background difference image f3 in which an animal body region is exclusively left.

However, as shown in an input image f5 of FIG. 2, in a case where a lighting condition such as a lighting color temperature or luminance is changed, or a camera parameter such as an aperture, a gain, and a white balance is changed, a region other than the animal body region is also changed. Therefore, as shown in FIG. 2, a difference value between a pixel value of a pixel of the reference background image f1 and a pixel value of a pixel of the input image f5 is not smaller than a predetermined threshold value, therefore an animal body region is not exclusively extracted, and accordingly a state like an image f7 in which a background image is also left is sometimes generated.

With respect to such the problem, a technique is proposed as a background difference image generation processing technique which is robust against variation of a lighting condition and the like. In the technique, an increase/decrease relationship between luminance of a target pixel and luminance of peripheral pixels is obtained and an animal body region is extracted by using a difference value of the relationship as an estimation value (refer to Y. Sato, S. Kaneko, and S. Igarashi “Robust Object Detection and Segmentation by Peripheral Increment Sign Correlation Image”, Institute of Electronics, Information and Communication Engineers Transactions, Vol. J84-D-II, No. 12, pp. 2585-2594, December 2001). According to this technique, since a relationship of brightness among the proximity pixels hardly changes even by an occurrence of lighting variation, a robust background difference image can be extracted.

As a technique for dealing with a case where a lighting condition and the like are gradually changed, background difference image generation processing employing a gaussian mixture model (GMM) is proposed. U.S. Patent Application Publication No. 6044166 discloses a technique by which generation processing of a robust background difference image is realized even when a lighting condition is gradually changed. In this technique, generation processing of a background difference image between an input image which is picked up and a reference background image is performed and pixel values, corresponding to each other, of a plurality of frames are compared to each other. In a case where the change is rapid, a pixel value of the reference background image is not updated, and in a case where the change is gradual, the pixel value of the reference background image is changed at a predetermined ratio so as to be close to a pixel value of the input image which is picked up.

Further, Japanese Unexamined Patent Application Publication No. 2009-265827 discloses such a technique for dealing with variation of a lighting condition. In the technique, a background image group composed of a plurality of background images obtained under different lighting conditions and the like is preliminarily acquired, an input image is divided into a prediction region in which an existence of an object is predicted and a non-prediction region which is a region other than the prediction region, and a background image having a characteristic closest to that of an image in the non-prediction region is selected from the background image group.

Further, as a method for automatically determining a case where rapid lighting variation occurs, such a technique is disclosed that when a size of a foreground which is a background difference image becomes larger than a predetermined size, an occurrence of a failure is determined (refer to Toyama, et al, “Wallflower: Principles and practice of background maintenance”, ICCV1999, Corfu, Greece). This technique is based on the premise that when rapid lighting variation occurs, a failure occurs in a background difference and a foreground image which is a background difference image is enlarged.

### SUMMARY OF THE INVENTION

However, in the technique of the above cited document “Robust Object Detection and Segmentation by Peripheral Increment Sign Correlation Image”, in a case of an object having a little texture, a relationship among proximity pixels may be collapsed due to lighting variation or a pixel noise, and thereby false detection may easily occur.

Further, in the technique of the above cited document “Wallflower: Principles and practice of background maintenance”, it is assumed that when the size of the foreground is larger than a predetermined size and the size of the foreground reaches 70%, for example, of the whole screen, it is considered that a failure occurs. In this case, when a person occupies a large area of a screen, for example, it may be falsely recognized that a failure occurs even though no failure occurs.

The technique of U.S. Patent Application Publication No. 6044166 is capable of dealing with a gradual change, but the technique is not effective when rapid lighting variation occurs because it is assumed that an animal body exists in the region where the rapid variation occurs.

The technique of Japanese Unexamined Patent Application Publication No. 2009-265827 is capable of dealing with a rapid change of a lighting condition by estimating a background which can be a foreground based on information of a part in which an object which is the foreground does not exist. However, it is necessary to preliminarily acquire a plurality of background images obtained under different lighting conditions.

It is desirable to exclusively extract an object which is a foreground image with high accuracy even when an input image is changed depending on an image pickup state.

An image processing device according to an embodiment of the present invention includes a reference background storage means for storing a reference background image; an estimation means for detecting an object from an input image and estimating an approximate position and an approximate shape of the object that is detected; a background difference image generation means for generating a background difference image obtained based on a difference value between the input image and the reference background image; a failure determination means for determining whether a failure occurs in the background difference image based on a comparison between the background difference image that is generated by the background difference image generation means and the object that is estimated by the estimation means; a failure type identification means for identifying a type of the failure; and a background image update means for updating the reference background image in a manner to correspond to the type of the failure.

The failure determination means may be allowed to compare the object to the background difference image so as to determine whether the failure occurs based on whether a ratio of a region of the background difference image with respect to a region of the object is larger than a predetermined ratio.

The image processing device may further include a change amount calculation means for calculating a change amount between pixels, which correspond to each other, in regions excluding region of the object, which is estimated by the estimation means, of the reference background image and the background difference image. In a case where the change amount is larger than a predetermined value, the failure type identification means may be allowed to identify a failure type as a color failure based on a color change, and in a case where the change amount is free from being larger than the predetermined value, the failure type identification means may be allowed to identify the failure type as a displacement failure based on displacement of an image pickup direction of the input image.

The image processing device may further include a motion vector calculation means for comparing the input image and the reference background image so as to obtain displacement of the image pickup direction of the input image as a motion vector, a motion compensation means for performing motion compensation with respect to the reference background image based on the motion vector so as to generate a motion compensation background image, a calculation means for calculating a relational formula of pixel values between pixels, which correspond to each other, in the reference background image and the region excluding the region of the object, which is estimated by the estimation means, of the background difference image, and a conversion means for converting the pixel value of the reference background image based on the relational formula so as to generate a pixel value conversion background image. When the failure type identified by the failure type identification means is the displacement failure, the background image update means may be allowed to substitute the reference background image with the motion compensation background image so as to update the reference background image, and when the failure type identified by the failure type identification means is the color failure, the background image update means may be allowed to substitute the reference background image with the pixel value conversion background image so as to update the reference background image.

When the failure determination means determines that there is no occurrence of a failure, the background image update means may be allowed to keep the reference background image as it is.

The motion vector calculation means may be allowed to compare the region excluding the region of the object in the reference background image to the region excluding the region of the object in the input image so as to obtain a motion vector by which a sum of difference absolute values between corresponding pixels of the images becomes the minimum.

An object detection means may be allowed to include a person detection means for detecting a person as an object, an animal detection means for detecting an animal as an object, and a vehicle detection means for detecting a vehicle as an object.

The person detection means may be allowed to include a face detection means for detecting a face image of the person from the input image, and a body mask estimation means for estimating a body mask from a position and a size in which a body of the person, the body of the person being estimated based on the face image that is detected by the face detection means, exists.

An image processing method, according to another embodiment of the present invention, of an image processing device, which includes a reference background storage means for storing a reference background image, an estimation means for detecting an object from an input image and estimating an approximate position and an approximate shape of the object that is detected, a background difference image generation means for generating a background difference image obtained based on a difference value between the input image and the reference background image, a failure determination means for determining whether a failure occurs in the background difference image based on a comparison between the background difference image that is generated by the background difference image generation means and the object that is estimated by the estimation means, a failure type identification means for identifying a type of the failure, and a background image update means for updating the reference background image in a manner to correspond to the type of the failure, includes the steps of storing the reference background image, in the reference background storage means, detecting the object from the input image and estimating the approximate position and the approximate shape of the object that is detected, in the estimation means, generating the background difference image based on the difference value between the input image and the reference background image, in the background difference image generation means, determining whether a failure occurs in the background difference image based on the comparison between the background difference image that is generated through processing of the step of generating a background difference image and the object that is estimated through processing of the step of estimating, in the failure determination means, identifying a type of the failure, in the failure type identification means, and updating the reference background image in a manner to correspond to the type of the failure, in the background image update means.

A program, according to still another embodiment of the present invention, allowing a computer that controls an image processing device, which includes a reference background storage means for storing a reference background image, an estimation means for detecting an object from an input image and estimating an approximate position and an approximate shape of the object that is detected, a background difference image generation means for generating a background difference image obtained based on a difference value between the input image and the reference background image, a failure determination means for determining whether a failure occurs in the background difference image based on a comparison between the background difference image that is generated by the background difference image generation means and the object that is estimated by the estimation means, a failure type identification means for identifying a type of the failure, and a background image update means for updating the reference background image in a manner to correspond to the type of the failure, to execute processing including the steps of storing the reference background image, in the reference background storage means, detecting the object from the input image and estimating the approximate position and the approximate shape of the object that is detected, in the estimation means, generating the background difference image based on the difference value between the input image and the reference background image, in the background difference image generation means, determining whether a failure occurs in the background difference image based on the comparison between the background difference image that is generated through processing of the step of generating a background difference image and the object that is estimated through processing of the step of estimating, in the failure determination means, identifying a type of the failure, in the failure type identification means, and updating the reference background image in a manner to correspond to the type of the failure, in the background image update means.

According to the embodiment of the present invention, the reference background image is stored, the object is detected from the input image, an approximate position and an approximate shape of the detected object are estimated, the background difference image obtained from the difference value between the input image and the reference background image is generated, whether a failure occurs in the background difference image is determined based on a comparison between the generated background difference image and the estimated object, a type of the failure is identified, and the reference background image is updated in a manner to correspond to the type of the failure.

The image processing device according to the embodiments of the present invention may be either an independent device or a block for performing image processing.

According to the embodiments of the present invention, an object to be a foreground image can be exclusively extracted with high accuracy even if an input image is changed due to an image pickup state.

### BRIEF DESCRIPTION OF THE DRAWINGS

FIG. 1 illustrates processing of the related art for object extraction by a background difference image;

FIG. 2 illustrates processing of the related art for object extraction by a background difference image;

FIG. 3 is a block diagram showing a configuration example of an image processing device according to an embodiment of the present invention;

FIG. 4 is a flowchart for illustrating reference background image storage processing;

FIG. 5 is a flowchart for illustrating background difference image extraction processing;

FIG. 6 is a flowchart for illustrating reference background image update processing;

FIG. 7 is a flowchart for illustrating object detection processing;

FIG. 8 illustrates a type of a failure;

FIG. 9 is a flowchart for illustrating failure type identification processing;

FIG. 10 illustrates the failure type identification processing;

FIG. 11 is a flowchart for illustrating updated background image generation processing;

FIG. 12 is a flowchart for illustrating color conversion update image generation processing;

FIG. 13 illustrates the color conversion update image generation processing;

FIG. 14 is a flowchart for illustrating motion compensation update image generation processing;

FIG. 15 illustrates the motion compensation update image generation processing; and

FIG. 16 illustrates a configuration example of a general-purpose personal computer.

### DESCRIPTION OF THE PREFERRED EMBODIMENTS

### [Configuration Example of Image Processing Device]

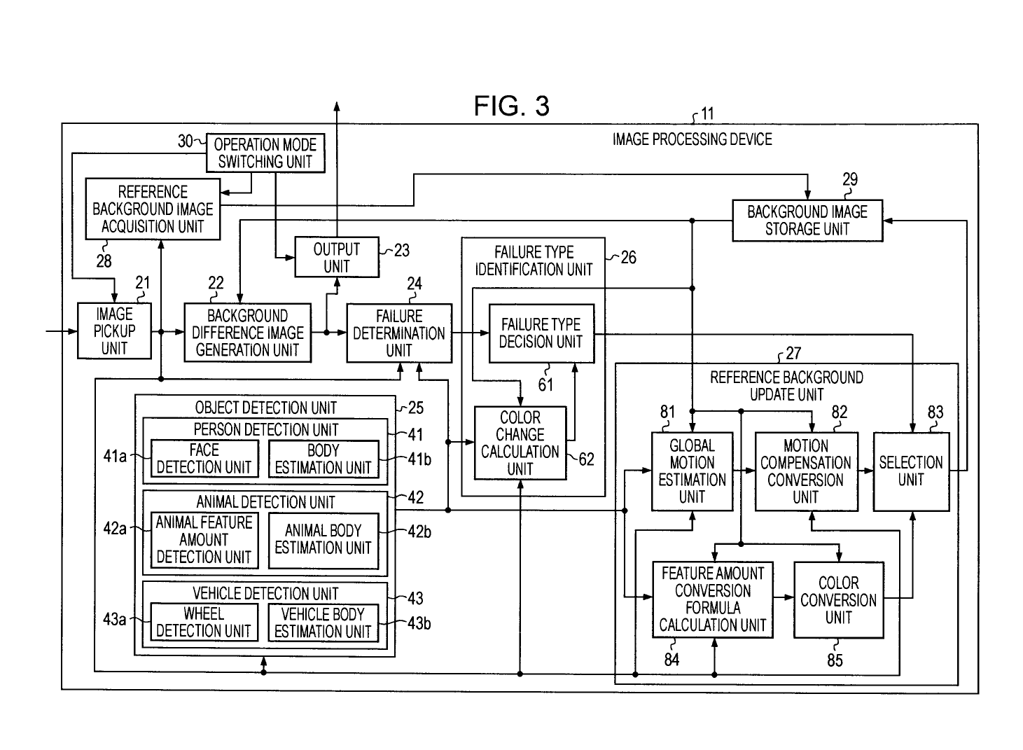

FIG. 3 illustrates a configuration example of hardware of an image processing device according to an embodiment of the present invention. An image processing device 11 of FIG. 3 specifies a position and a shape of an object which is a foreground from an input image which is picked up and exclusively extracts a region of the object.

The image processing device 11 includes an image pickup unit 21, a background difference image generation unit 22, an output unit 23, a failure determination unit 24, an object detection unit 25, a failure type identification unit 26, a reference background update unit 27, a reference background image acquisition unit 28, a background image storage unit 29, and an operation mode switching unit 30.

The image pickup unit 21 picks up an image basically in a state that an image pickup direction, a focal position, and the like are fixed, and supplies the picked-up image to the background difference image generation unit 22, the failure determination unit 24, the object detection unit 25, the reference background update unit 27, and the reference background image acquisition unit 28.

The background difference image generation unit 22 obtains a difference absolute value between a pixel value of a pixel of the picked-up image received from the image pickup unit 21 and a pixel value of a pixel of a background image which is stored in the background image storage unit 29 for every pixel. Then, the background difference image generation unit 22 generates a background difference image of which a pixel value of a pixel, which corresponds to pixels between which the difference absolute value is higher than a predetermined value is set to be a pixel value of the picked-up image and pixel values of pixels corresponding to other pixels are set to be zero or the maximum pixel value, and the background difference image generation unit 22 supplies the background difference image to the output unit 23 and the failure determination unit 24. That is, when it is assumed that a background image having no object is stored in the background image storage unit 29, and when an object exists in the picked-up image, an image of which pixel values of a region of the object are exclusively extracted is ideally obtained as a background difference image by this processing.

The output unit 23 outputs the background difference image which is supplied from the background difference image generation unit 22 and, for example, stores the background difference image in a storage medium (not shown) or displays the background difference image on a display unit (not shown).

The object detection unit 25 detects an object existing in the picked-up image and supplies an image of the object (information of a region which is composed of pixels constituting the object) to the failure determination unit 24, the failure type identification unit 26, and the reference background update unit 27. In more detail, the object detection unit 25 includes a person detection unit 41, an animal detection unit 42, and a vehicle detection unit 43 which respectively detects an image of a person, an image of an animal, and an image of a vehicle as objects. The object detection unit 25 detects images of a person, an animal, and a vehicle in the picked-up image as objects and supplies the detected images of regions of the objects to the failure determination unit 24, the failure type identification unit 26, and the reference background update unit 27 as object masks.

The person detection unit 41 includes a face detection unit 41a and a body estimation unit 41b. The face detection unit 41a detects a face image of a person existing in the picked-up image. The body estimation unit 41b estimates a region in which a body exists based on a position and a size of the face image which is detected by the face detection unit 41a. Then, the person detection unit 41 generates a body mask by combining the region of the face image and the estimated body region, as a detection result. The animal detection unit 42 includes an animal feature amount detection unit 42a and an animal body estimation unit 42b. The animal feature amount detection unit 42a extracts a face image of an animal, an image of four limbs, for example, and positions and sizes of the images as a feature amount. The animal body estimation unit 42b estimates a region in which a body of the animal as an object exists and a size of the region based on the position of the face image of the animal and the feature amount of the image of four limbs. Then, the animal detection unit 42 generates an animal body mask by combining the region of the face image of the animal and the estimated body region, as a detection result. The vehicle detection unit 43 includes a wheel detection unit 43a and a vehicle body estimation unit 43b. The wheel detection unit 43a detects information of a position and a size of a region which corresponds to wheels of a vehicle from the image. The vehicle body estimation unit 43b estimates a position and a size of a region of the vehicle body based on the detected information of the position and the size of the region of the wheels. The vehicle detection unit 43 generates a vehicle body mask by combining the estimated region of the vehicle body and the region of the wheels, as a detection result.

The object detection unit 25 of FIG. 3 detects images of a person, an animal, and a vehicle as examples of objects to be detected, but the object detection unit 25 may be set to detect other objects.

The failure determination unit 24 determines whether the size of the background difference image is extremely larger than the size of the object mask based on the sizes of the background difference image and the object mask, and based on this result, determines whether a failure occurs in background difference image generation processing of the background difference image generation unit 22. Then, the failure determination unit 24 supplies the determination result to the failure type identification unit 26.

The failure type identification unit 26 identifies a type of a failure based on the failure determination result of the failure determination unit 24, the reference background image stored in the background image storage unit 29, the object mask from the object detection unit 25, and the picked-up image. The identification result includes a result that no failure occurs. Then, the failure type identification unit 26 supplies information of the identified failure type to the reference background update unit 27.

In more detail, the failure type identification unit 26 includes a failure type decision unit 61 and a color change calculation unit 62. The color change calculation unit 62 calculates an average of pixel values of a region excluding the region of the object mask in the picked-up image and an average of pixel values of a region excluding the region of the object mask in the reference background image or calculates a hue change and supplies the calculation result to the failure type decision unit 61 as a difference value of a color feature amount. When the determination result of the failure determination unit 24 shows an occurrence of a failure and, in addition, when the difference value of the color feature amount is larger than a predetermined threshold value, the failure type decision unit 61 decides a failure type as a color failure which is caused by a large change of lighting within the picked-up image or a change of a white balance. On the other hand, when the determination result of the failure determination unit 24 shows an occurrence of a failure and, in addition, when the difference value of the color feature amount is not larger than the predetermined threshold value, the failure type decision unit 61 decides the failure type as a displacement failure which is caused by displacement of an image pickup range of the image pickup unit 21 which picks up a pickup image. Further, when the determination result of the failure determination unit 24 shows no occurrence of a failure, the failure type decision unit 61 decides information showing no occurrence of a failure as information for identifying a failure type. That is, the failure type identification unit 26 identifies one of three types: a type that no failure occurs in the background difference image generation processing, a type that a failure caused by a color failure occurs, and a type that a failure caused by a displacement failure occurs, based on the failure determination result, the object mask, the reference background image, and the picked-up image.

The reference background update unit 27 updates the reference background image based on the information of the failure type, which is received from the failure type identification unit 26, from the information of the object mask, the reference background image stored in the background image storage unit 29, and the picked-up image and stores the updated reference background image in the background image storage unit 29. In more detail, the reference background update unit 27 includes a global motion estimation unit 81, a motion compensation conversion unit 82, a selection unit 83, a feature amount conversion formula calculation unit 84, and a color conversion unit 85.

The global motion estimation unit 81 estimates a global motion which shows a direction and a magnitude of displacement of the image pickup direction of the image pickup unit 21 as a motion vector based on information of the reference background image and the picked-up image excluding the region of the object mask and supplies the motion vector to the motion compensation conversion unit 82. The motion compensation conversion unit 82 generates a motion compensation image which is an updated image of the reference background image from the reference background image which is currently stored in the background image storage unit 29 and the picked-up image based on the motion vector and supplied the motion compensation image to the selection unit 83. The feature amount conversion formula calculation unit 84 obtains a conversion formula that shows a color change between pixels of the picked-up image excluding the object mask and corresponding pixels of the reference background image currently stored in the background image storage unit 29 by a least-square method and supplies the obtained conversion formula to the color conversion unit 85. The color conversion unit 85 converts a pixel value of each pixel of the reference background image stored in the background image storage unit 29 by using the conversion formula obtained by the feature amount conversion formula calculation unit 84 so as to generate a color conversion image which is an updated image of the reference background image and supply the color conversion image to the selection unit 83. The selection unit 83 selects one of the motion compensation image supplied from the motion compensation conversion unit 82, the color conversion image supplied from the color conversion unit 85, and the picked-up image, based on the failure type supplied from the failure type identification unit 26. Then, the selection unit 83 replaces the reference background image stored in the background storage unit 29 with the selected image so as to update the reference background image.

When a reference background image is initially registered, the reference background image acquisition unit 28 regards an image supplied from the image pickup unit 21 as the reference background image and allows the background image storage unit 29 to store the image.

The operation mode switching unit 30 controls an operation mode of the image processing device 11 and switches three kinds of operation modes which are a reference background image storage mode, a background difference image extraction mode, and a background image update mode. Here, in FIG. 3, arrows denoting ON/OFF control of operations by the operation mode switching unit 30 are drawn from the operation mode switching unit 30 only to the image pickup unit 21, the output unit 23, and the reference background image acquisition unit 28. However, the operation mode switching unit 30 actually controls all elements from the image pickup unit 21 to the background image storage unit 29 to turn the elements ON or OFF in each operation mode. Accordingly, arrows should be actually drawn to all of the elements, but the drawing shows the simplified configuration so as to avoid showing the too complicated configuration.

### [Reference Background Image Storage Processing]

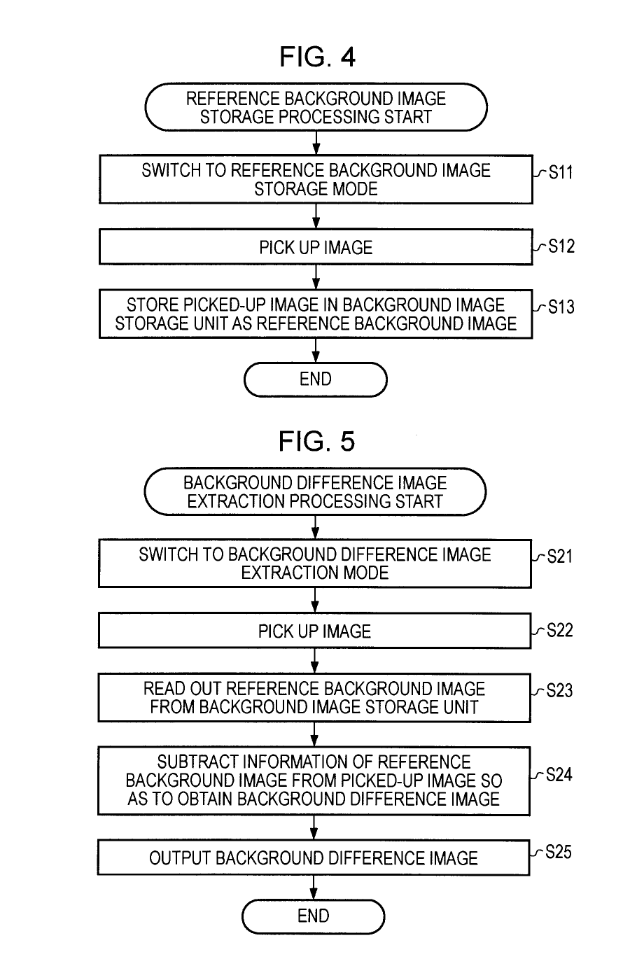

Reference background image storage processing is next described with reference to a flowchart of FIG. 4.

In step S11, in order to turn the image processing device 11 to the reference background image storage mode, the operation mode switching unit 30 controls to turn on the image pickup unit 21, the reference background image acquisition unit 28, and the background image storage unit 29 that are necessary for the operation and turn off the rest of the elements. Here, the reference background image storage mode is an operation mode that is set based on an operation signal which is generated when a user of the image processing device 11 operates an operation unit which is not shown. Accordingly, this operation mode is set on the premise that the image pickup unit 21 is set by the user to be in a state that the image pickup unit 21 can pick up an image which is to be a reference background image and from which an object is to be extracted in the following operation.

In step S12, the image pickup unit 21 picks up an image in a fixed image pickup direction and supplies the image which is picked up to the reference background image acquisition unit 28 as a picked-up image.

In step S13, the reference background image acquisition unit 28 acquires the picked-up image which is supplied from the image pickup unit 21 as a reference background image and stores the picked-up image in the background image storage unit 29.

Through the above-described processing, a background image which is the reference in the following processing is stored in the background image storage unit 29.

### [Background Difference Image Extraction Processing]

Background difference image extraction processing is next described with reference to a flowchart of FIG. 5. Here, this processing is on the premise that a reference background image is stored in the background image storage unit 29 by the above-described reference background image storage processing.

In step S21, in order to turn the image processing device 11 to the background difference image extraction mode, the operation mode switching unit 30 controls to turn on the image pickup unit 21, the background difference image generation unit 22, the output unit 23, and the background image storage unit 29 that are necessary for the operation and turn off the rest of the elements.

In step S22, the image pickup unit 21 picks up an image in an image pickup direction which is fixed in the same state as the state that the reference background image is picked up, and supplies the image which is picked up to the background difference image generation unit 22.

In step S23, the background difference image generation unit 22 reads out the reference background image which is stored in the background image storage unit 29.

In step S24, the background difference image generation unit 22 calculates a difference between a pixel value of a pixel of the reference background image and a pixel value of a corresponding pixel of the picked-up image for every pixel and compares the obtained difference value to a predetermined threshold value. Then, when the difference value is smaller than the predetermined threshold value, the background difference image generation unit 22 sets the pixel value of the corresponding pixel to zero or the highest pixel value, and when the difference value is larger than the predetermined threshold value, the background difference image generation unit 22 sets the pixel value of the corresponding pixel to a pixel value of the pixel of the picked-up image, so as to generate a background difference image and supply the background difference image to the output unit 23.

In step S25, the output unit 23 displays the background difference image on a display unit which is not shown or stores the background difference image in a storage medium which is not shown.

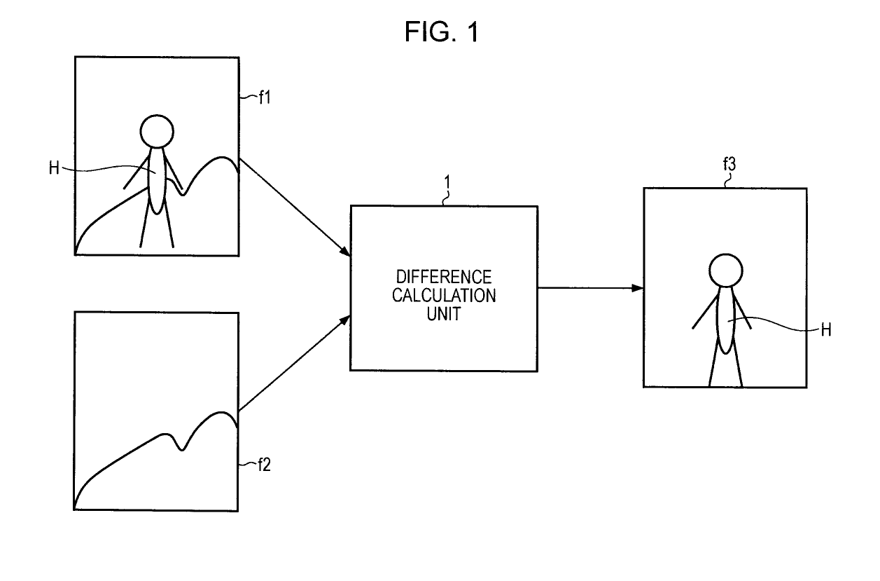

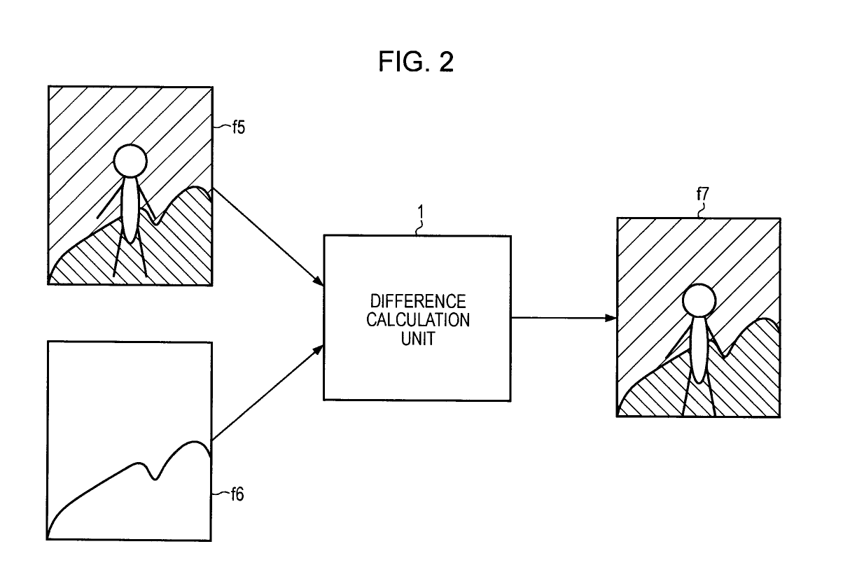

Through the above-described processing, in a case where the reference background image f1 of FIG. 1 is stored in the background image storage unit 29 and the picked-up image f2 of FIG. 1 is picked up, an image which is obtained by extracting exclusively a person who is an object is ideally generated as shown by the background difference image f3.

### [Reference Background Image Update Processing]

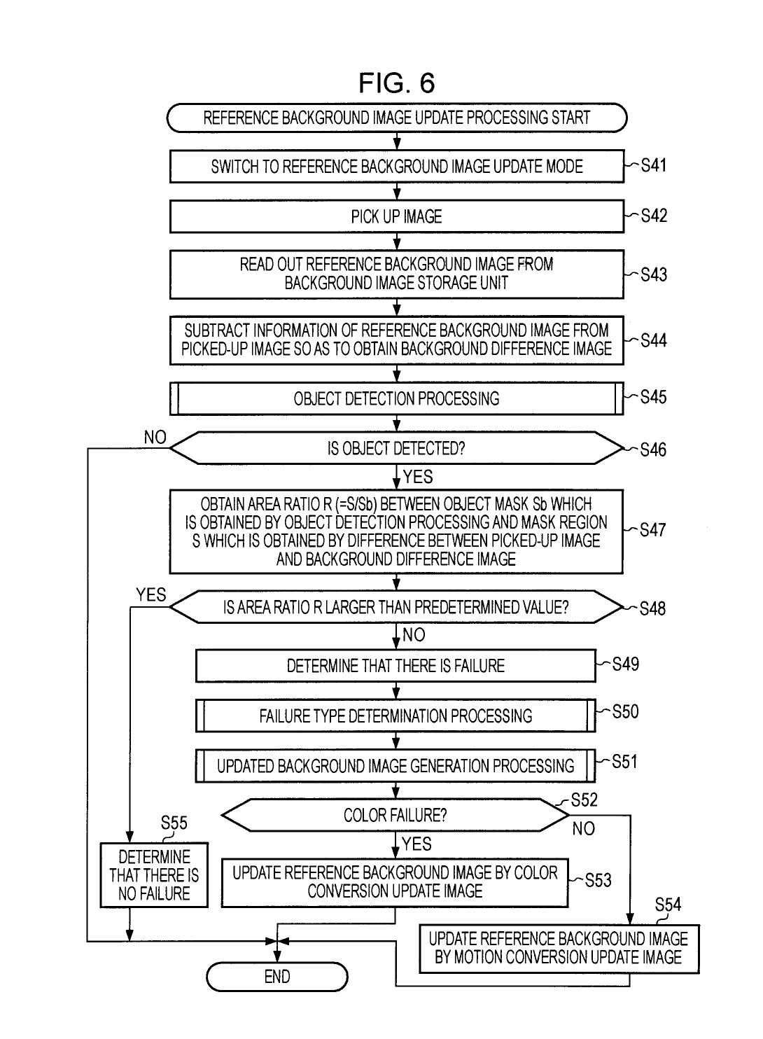

Reference background image update processing is next described with reference to a flowchart of FIG. 6.

In step S41, in order to turn the image processing device 11 to the reference background image update mode, the operation mode switching unit 30 controls to turn off the output unit 23 and the reference background image acquisition unit 28 that are not necessary for the operation and turn on the rest of the elements.

In step S42, the image pickup unit 21 picks up an image in an image pickup direction which is fixed in the same state as the state that the reference background image is picked up, and supplies the image which is picked up to the background difference image generation unit 22, the failure determination unit 24, the object detection unit 25, the failure type identification unit 26, and the reference background update unit 27.

In step S43, the background difference image generation unit 22 reads out the reference background image which is stored in the background image storage unit 29.

In step S44, the background difference image generation unit 22 calculates a difference between a pixel value of a pixel of the reference background image and a pixel value of a corresponding pixel of the picked-up image for every pixel and compares the obtained difference value to a predetermined threshold value. Then, when the difference value is smaller than the predetermined threshold value, the background difference image generation unit 22 sets the pixel value of the corresponding pixel to zero or the highest pixel value, and when the difference value is larger than the predetermined threshold value, the background difference image generation unit 22 sets the pixel value of the corresponding pixel to a pixel value of the pixel of the picked-up image, so as to generate a background difference image and supply the background difference image to the failure determination unit 24.

In step S45, the object detection unit 25 performs object detection processing so as to detect presence/absence of a person, an animal, and a vehicle which are objects. When the object detection unit 25 detects presence of a person, an animal, and a vehicle, the object detection unit 25 supplies an object mask which is a detection result to the failure determination unit 24, the failure type identification unit 26, and the reference background update unit 27.

### [Object Detection Processing]

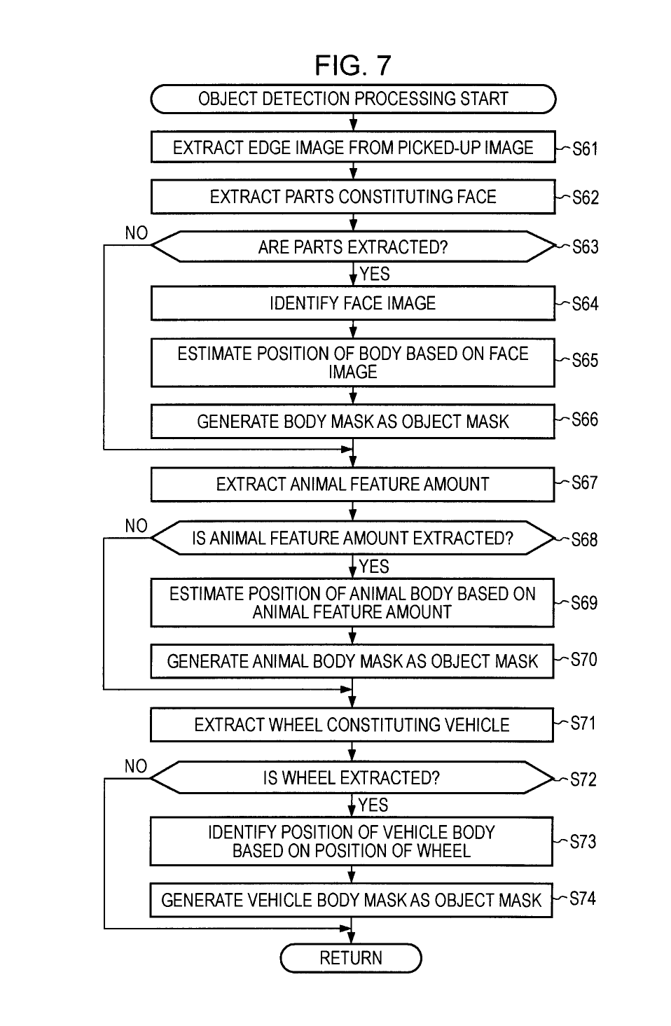

Here, the object detection processing is described with reference to a flowchart of FIG. 7.

In step S61, the object detection unit 25 executes Laplacian filter processing or Sobel filter processing with respect to the picked-up image so as to extract an edge image.

In step S62, the person detection unit 41 controls the face detection unit 41a so as to extract parts which can constitute a face image based on shapes of the parts from the edge image. In more detail, the face detection unit 41a detects and extracts frameworks of parts such as an eye, a nose, a mouth, and an ear which constitute a face, based on shapes of the parts, from the edge image.

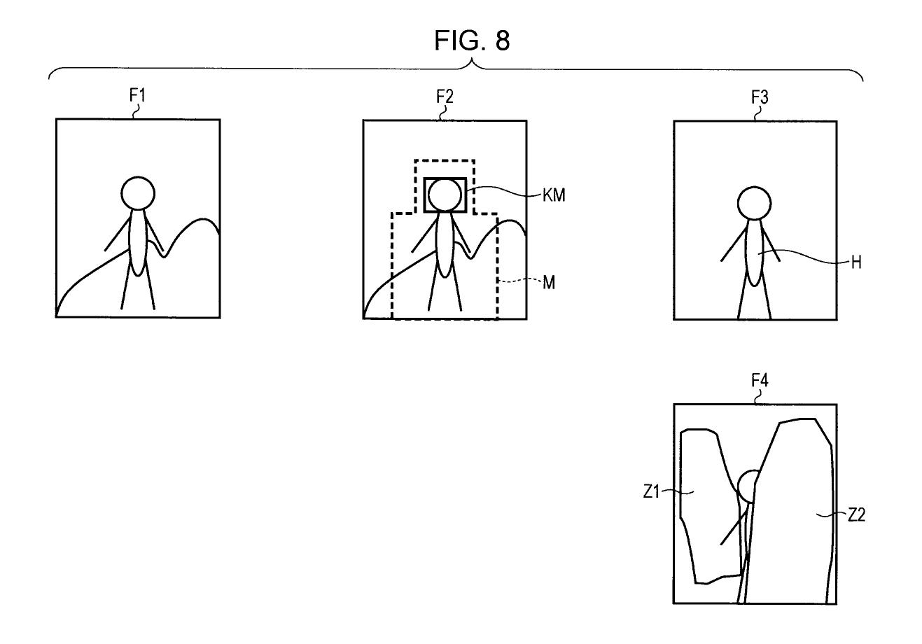

In step S63, the person detection unit 41 controls the face detection unit 41a so as to allow the face detection unit 41a to determine whether parts which constitute a face image are extracted or not. When the parts are extracted in step S63, the person detection unit 41 controls the face detection unit 41a so as to allow the face detection unit 41a to identify a region of the face image based on positions, an arrangement, and sizes of the extracted parts and further identify a rectangular face image in step S64. That is, in a case of a picked-up image including a person as an image F1 shown in FIG. 8, for example, a face image (face mask) KM in an image F2 of FIG. 8 is identified. Here, the rectangular face image shown in FIG. 8 is referred to below as a face mask KM.

In step S65, the person detection unit 41 controls the body estimation unit 41b so as to allow the body estimation unit 41b to estimate a region of a body of the person based on the position of the rectangular face image which is identified. That is, in a case of the image F2 of FIG. 8, when the face mask KM is identified, the body estimation unit 41b estimates a shape, a size, and a position of the body region based on the position, the size, and the direction of the face mask KM.

In step S66, the person detection unit 41 generates a person body mask M, which includes a region in which a person as an object is picked up, as an object mask based on the region obtained by adding the body region which is estimated by the body estimation unit 41b and the region of the face mask KM. Then, the person detection unit 41 supplies the object mask which is the body mask M showing that a person is detected as an object to the failure determination unit 24, the failure type identification unit 26, and the reference background update unit 27.

Here, when it is determined that no parts are extracted in step S63, it is considered that no person region exists in the picked-up image, whereby processing from step S64 to S66 are skipped.

In step S67, the animal detection unit 42 controls the animal feature amount detection unit 42a so as to extract a feature amount which can constitute an animal from the edge image. That is, the animal feature amount is, for example, parts such as an eye, a nose, a mouth, and an ear of a face image, four limbs, a tail, and the like which constitute an animal, and the feature amount that can constitute an animal which is an object is detected based on shapes of these parts and the like.

In step S68, the animal detection unit 42 controls the animal feature amount detection unit 42a so as to determine whether the animal feature amount is extracted or not. When the animal feature amount is extracted in step S68, the animal detection unit 42 controls the animal body estimation unit 42b so as to allow the animal body estimation unit 42b to estimate a shape, a size, and a position of a body region including a head of the animal in the picked-up image based on the detected animal feature amount, in step S69.

In step S70, the animal detection unit 42 generates an object mask of an animal which covers a region in a range of a body region which is estimated by the animal body estimation unit 42b and includes the head of the animal. Then, the animal detection unit 42 supplies the object mask which shows that the animal is detected as an object to the failure determination unit 24, the failure type identification unit 26, and the reference background update unit 27.

Here, when it is determined that no animal feature amount is extracted in step S68, it is considered that no animal region exists in the picked-up image, whereby the processing of step S69 and S70 are skipped.

In step S71, the vehicle detection unit 43 controls the wheel detection unit 43a so as to allow the wheel detection unit 43a to detect a wheel image which is a feature amount of a vehicle from the edge image.

In step S72, the vehicle detection unit 43 controls the wheel detection unit 43a so as to determine whether a wheel image can be detected or not. When it is determined that the wheel can be detected in step S72, the vehicle detection unit 43 controls the vehicle body estimation unit 43b so as to allow the vehicle body estimation unit 43b to estimate a position and a size of a vehicle body region based on the position and the size of the detected wheel image in step S73.

In step S74, the vehicle detection unit 43 generates an object mask of a vehicle which covers a region in a range of a vehicle body region which is estimated by the vehicle body estimation unit 43b. Then, the vehicle detection unit 43 supplies the object mask which shows that the vehicle is detected as an object to the failure determination unit 24, the failure type identification unit 26, and the reference background update unit 27.

Here, when it is determined that no wheel can be detected in step S72, it is considered that no vehicle region exists in the picked-up image, whereby the processing of steps S73 and S74 are skipped.

That is, when all of a person, an animal, and a vehicle or any one of the person, the animal, and the vehicle is detected as an object through the above-described processing, an object mask corresponding to the detected object is generated and supplied to the failure determination unit 24, the failure type identification unit 26, and the reference background update unit 27. Here, a person, an animal, and a vehicle are detected as objects in this example, but objects other than these may be detected.

The description goes back to the flowchart of FIG. 6.

When the object detection processing is executed in step S45, the failure determination unit 24 determines whether an object is detected or not based on whether the object mask is supplied from the object detection unit 25, in step S46. When no object is detected in step S45, the reference background image update processing is ended. That is, in this case, since the object mask is not detected and it is difficult to determine whether update of the reference background image is necessary or not in the following processing, the reference background image is not updated and the processing is ended. On the other hand, when the object mask is detected in step S45, it is considered that an object is detected and the processing goes to step S47.

In step S47, the failure determination unit 24 calculates an area ratio between an area Sb of the object mask which is detected through the object detection processing and an area of a region, of which a pixel value is not zero as a difference result, of the background difference image. Namely, the failure determination unit 24 calculates an area ratio R (=S/Sb) between the area Sb of the object mask and the region, of which the pixel value is not zero as the difference result, of the background difference image, that is, the region which is substantially obtained as a mask from the background difference image.

In step S48, the failure determination unit 24 determines whether the area ratio R is larger than a predetermined threshold value or not. That is, when the object is a person and the image F1 of FIG. 8 is an input image, the size of the object mask M covers a slightly larger range than a region of a person H (FIG. 8) as shown by an object mask M of the image F2 of FIG. 8. On the other hand, when the background difference image is obtained in an ideal state, a mask image substantially covers only the region of the person H as shown in the image F3 of FIG. 8. Accordingly, since the area Sb of the person H of the image F3 is smaller than the area S of the object mask M which is obtained through the object detection processing as shown in the image F2 of FIG. 8, the area ratio R should have a smaller value than the predetermined threshold value which is larger than 1. However, when some sort of failure occurs in the background difference image, a region which should be obtained only in the region of the person H under normal circumstances appears in a region of an image which should be a background. For example, as shown in an image F4 of FIG. 8, regions shown as failure regions Z1 and Z2 appear and the whole region including the failure regions Z1 and Z2 is obtained as an area of a mask region obtained from the background difference image. As a result, the area Sb of the region which is obtained as the background difference image becomes extremely large, and consequently, the area ratio R has an extremely small value when a failure occurs. Accordingly, when the area ratio R is larger than the predetermined threshold value, it can be determined that no failure occurs in the background difference image generation processing.

When the area ratio R is larger than the predetermined threshold value, the failure determination unit 24 determines that no failure occurs in step S48. Then, the processing goes to step S55 and the failure determination unit 24 notifies the failure type identification unit 26 that there is no occurrence of a failure. In this case, since it is not necessary to update the reference background image due to no occurrence of a failure, the processing is ended.

When the area ratio R is not larger than the predetermined threshold value in step S48, the failure determination unit 24 determines that a failure occurs and the processing goes to step S49. In step S49, the failure determination unit 24 notifies the failure type identification unit 26 that there is an occurrence of a failure.

In step S50, the failure type identification unit 26 determines that there is an occurrence of a failure and executes failure type identification processing so as to identify a type of the failure. Thus, the failure type identification unit 26 identifies the type of the failure which occurs.

### [Failure Type Identification Processing]

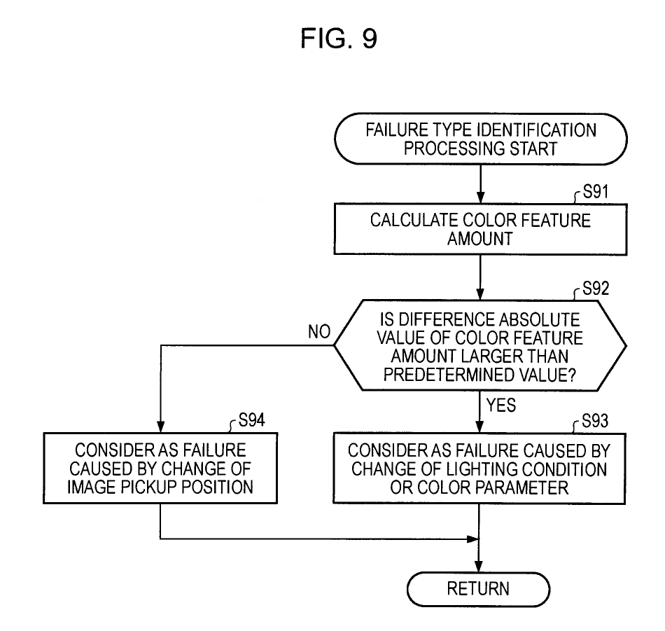

Here, the failure type identification processing is described with reference to a flowchart of FIG. 9.

In step S91, the color change calculation unit 62 calculates change of a color feature amount in the region excluding the object mask in the picked-up image and the reference background image in order to determine whether the failure is based on presence/absence of changes of a lighting condition and a color parameter which are an image pickup environment of an image which is picked up by the image pickup unit 21. In more detail, the color change calculation unit 62 calculates an average value of a pixel and pixels adjacent to the pixel for every pixel in the region excluding the object mask in the picked-up image and the reference background image. In furthermore detail, the color change calculation unit 62 calculates an average value of five pixels, which is composed of a pixel, pixels positioned in the vertical direction of the pixel, and pixels positioned in the horizontal direction of the pixel, for every pixel of the picked-up image and the reference background image, for example. Further, the color change calculation unit 62 calculates an average value, in the whole image, of average values of pixels adjacent to every pixel of the picked-up image and the reference background image as a color feature amount in each of the images and supplies the average value to the failure type decision unit 61.

In step S92, the failure type decision unit 61 calculates a difference absolute value between the color feature amount of the picked-up image and the color feature amount of the reference background image and determines whether the difference absolute value is larger than a predetermined threshold value or not. That is, it is considered that when a lighting condition or a color parameter in an environment which is picked up by the image pickup unit 21 changes, the color feature amount changes. Therefore, it is considered that the difference absolute value between the color feature amount of the picked-up image and the color feature amount of the reference background image change more largely than the predetermined threshold value. Accordingly, when the difference absolute value of the color feature amounts is larger than the predetermined threshold value in step S92, the failure type decision unit 61 determines that the failure type is a failure which is caused by a change of the lighting condition or the color parameter in the background difference image generation processing, namely, a color failure, in step S93. Here, the color feature amount is obtained by using the average values of adjacent pixels of each pixel in the above example. However, a color phase of each pixel may obtained and whether there is an occurrence of a color failure or not may be determined by using change of the color phases of the picked-up image and the reference background image.

On the other hand, when the difference absolute value between the color feature amounts of the picked-up image and the reference background image is not larger than the predetermined threshold value in step S92, the processing goes to step S94.

In step S94, the failure type decision unit 61 determines that the failure type is a failure which is caused by displacement of the image pickup position of the image pickup unit 21 in the background difference image generation processing, namely, a displacement failure.

Through the above-described processing, the failure type decision unit 61 obtains change of the color feature amounts and thereby identifies that the failure is a color failure which is caused by change of a lighting condition of the environment which is picked up by the image pickup unit 21 or a displacement failure which is caused by displacement of the image pickup direction of the image pickup unit 21.

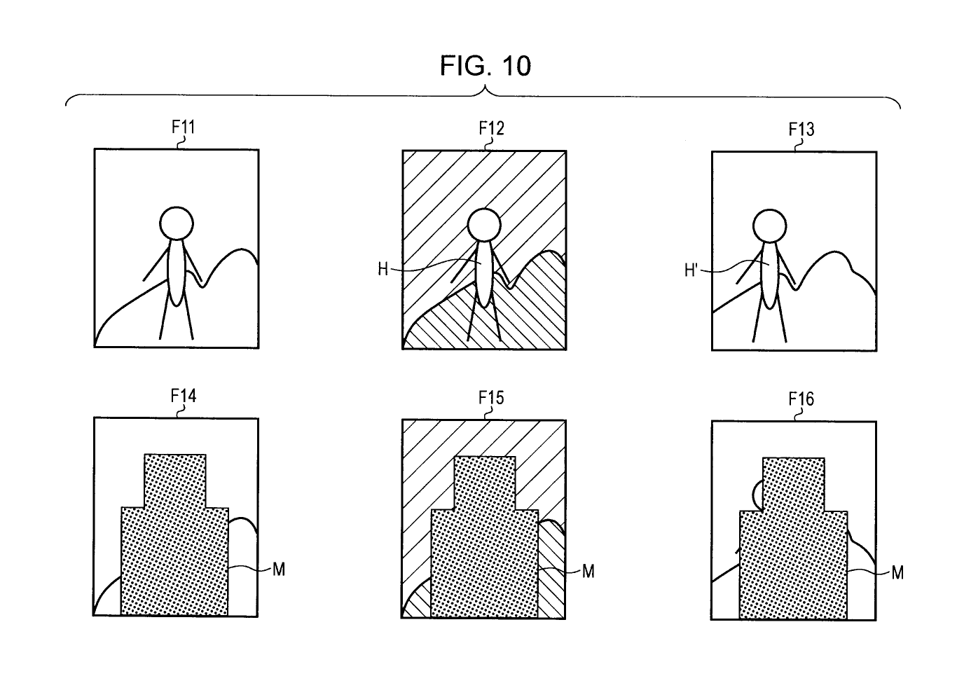

That is, in a case where change of a lighting condition or displacement of the image pickup direction does not occur as shown in the image F1 of FIG. 8 with respect to the reference background image shown as an image F11 of FIG. 10, when an image including the person H is picked up, the object mask M shown in an image F14 of FIG. 10 is obtained. In this case, since change with respect to the reference background image does not occur in a range excluding the object mask M, a failure as shown in the image F4 of FIG. 8, for example does not occur.

On the other hand, as shown in an image F12 of FIG. 10, when an image including the person H is picked up in a state that the lighting condition of the image which is picked up by the image pickup unit 21 is changed, a background part which is not an object appears in the background difference image excluding the object mask M due to the change of the lighting condition. Therefore, when the background difference image is obtained, the failure shown in the image F4 of FIG. 8 may occur.

Further, the image pickup direction of the image pickup unit 21 is displaced as shown in an image F13 of FIG. 10 and therefore a person who is an object and a background are displaced to the left side as a person H′ (refer to an image F13). In this case, the person H′ is included in an image in a range excluding the object mask M and further, a mountain which is the background is displaced as shown in an image F16. As a result, when the background difference image is obtained, a failure shown in the image F4 of FIG. 8 may occur.

The lighting condition is changed in the images F12 and F15 in the comparison described above, so that the difference absolute value of the color feature amounts in the region excluding the object mask M largely changes with respect to the reference background image F11. On the other hand, in a case where the image pickup direction of the image pickup unit 21 is merely displaced as shown in the images F13 and F16, the difference absolute value between the color feature amounts does not largely change. The failure type can be identified based on such characteristic difference.

Here, the description goes back to the flowchart of FIG. 6.

When the failure type is identified in step S50, the reference background update unit 27 executes updated background image generation processing so as to generate an updated background image which corresponds to each failure type and is used for an update of the reference background image, in step S51.

### [Updated Background Image Generation Processing]

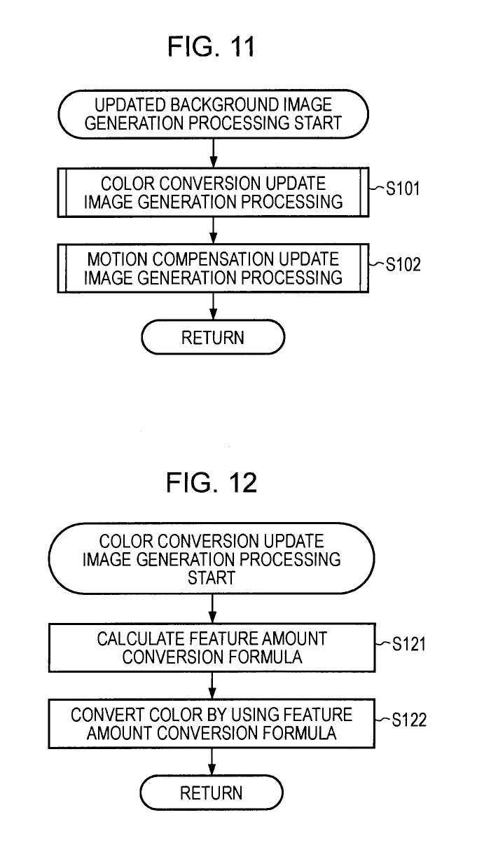

Here, the updated background image generation processing is described with reference to a flowchart of FIG. 11.

In step S101, the reference background update unit 27 executes color conversion update image generation processing so as to generate a color conversion update image.

### [Color Conversion Update Image Generation Processing]

Here, the color conversion update image generation processing is described with reference to a flowchart of FIG. 12.

In step S121, the reference background update unit 27 controls the feature amount conversion formula calculation unit 84 so as to allow the feature amount conversion formula calculation unit 84 to calculate a feature amount conversion formula by using pixels in a region excluding the object mask in the picked-up image and the reference background image which is stored in the background image storage unit 29, and supplies the feature amount conversion formula to the color conversion unit 85.

Here, the feature amount conversion formula is formula (1) below, for example.

r_{di}=arₛᵢ+b (1)

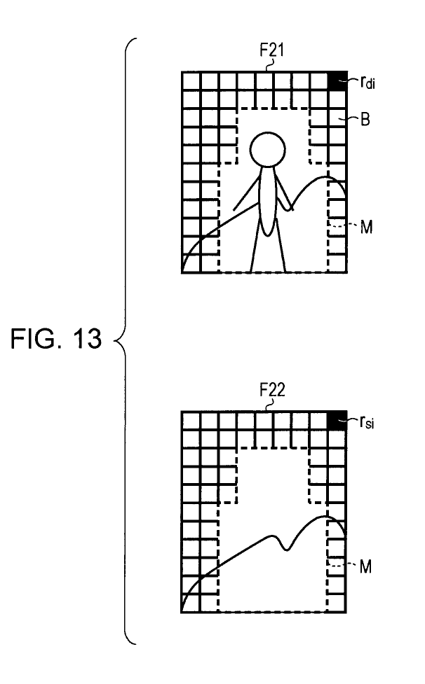

Here, r_{di} denotes a pixel value of a pixel in the region excluding the region of the object mask M in a picked-up image F21 shown in the upper part of FIG. 13, and rₛᵢ denotes a pixel value of a pixel in the region excluding the region of the object mask M in a reference background image F22 shown in the lower part of FIG. 13, for example. Further, a and b respectively denote coefficients (linear approximation coefficient) of the feature amount conversion formula, and i denotes an identifier for identifying corresponding pixels of the picked-up image F21 and the reference background image F22.

That is, the feature amount conversion formula expressed as formula (1) is used for converting a pixel value rₛᵢ of each pixel of the region, excluding the region of the object mask M, in the reference background image into a pixel value r_{di} of each pixel of the picked-up image as shown in FIG. 13. Accordingly, the feature amount conversion formula calculation unit 84 can obtain a feature amount conversion formula by calculating coefficients a and b.

In more detail, in order to obtain a feature amount conversion formula, it is sufficient to obtain coefficients a and b which minimize formula (2) below which is obtained by deforming formula (1).

$${\sum }_{i = 1}^{N} \vert {r}_{di} - ( {ar}_{si} - b ) \vert \qquad ( 2 )$$

Here, N is a variable denoting the number of pixels. That is, formula (2) expresses a value, which is obtained by integrating differences between a value which is obtained by substituting the pixel value rₛᵢ of each pixel of a region excluding the region of the object mask in the reference background image into the feature amount conversion formula and the pixel value r_{di} of each pixel of a region excluding the region of the object mask in the picked-up image, for all pixels.

Therefore, the feature amount conversion formula calculation unit 84 calculates coefficients a and b by a least-square method as shown in formula (3) below by using respective pixels corresponding to each other in the region excluding the object mask in the picked-up image and the reference background image.

$$a = \frac{N {\sum }_{i = 1}^{N} {r}_{si} {r}_{di} - {\sum }_{i = 1}^{N} {r}_{si} {\sum }_{i = 1}^{N} {r}_{di}}{n {\sum }_{i = 1}^{N} {r}_{si}^{2} - {( {\sum }_{i = 1}^{N} {r}_{di} )}^{2}} \\ b = \frac{{\sum }_{i = 1}^{N} {r}_{di}^{2} {\sum }_{i = 1}^{N} {r}_{di} - {\sum }_{i = 1}^{N} {r}_{si} {r}_{di} {\sum }_{i = 1}^{N} {r}_{si}}{n {\sum }_{i = 1}^{N} {r}_{si}^{2} - {( {\sum }_{i = 1}^{N} {r}_{si} )}^{2}} \qquad ( 3 )$$

That is, the feature amount conversion formula calculation unit 84 obtains the above-mentioned coefficients a and b by calculation as expressed by formula (3) so as to calculate a feature amount conversion formula. In the above example, a feature amount conversion formula is obtained by adopting a linear approximation function. However, other approximation functions may be used as long as the functions enables conversion of a pixel value of each pixel of the reference background image into a pixel value of each pixel of the picked-up image excluding the region of the object mask. For example, a feature amount conversion formula may be obtained by employing a polynomial approximation function.

In step S122, the color conversion unit 85 converts colors of all pixels of the reference background image by using the obtained feature amount conversion formula so as to generate a color conversion update image and supply the color conversion update image to the selection unit 83.

Through the above-described processing, even if the picked-up image is changed with respect to the reference background image due to change of a lighting condition or change of a color parameter such as a white balance, the reference background image can be updated while corresponding to the change and thus a color conversion update image can be generated. Accordingly, a failure which is caused by a color failure described above in the background difference image generation processing can be suppressed.

Here, the description goes back to the flowchart of FIG. 11.

After the color conversion update image is generated through the color conversion update image generation processing in step S101, the reference background update unit 27 executes motion compensation update image generation processing so as to generate a motion compensation update image in step S102.

### [Motion Compensation Update Image Generation Processing]

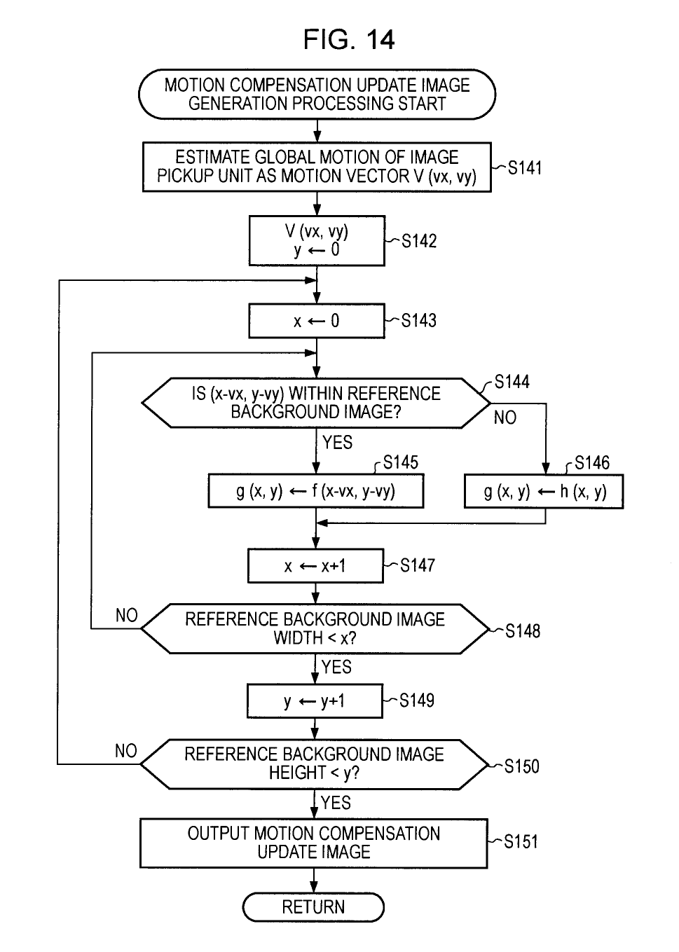

Here, the motion compensation update image generation processing is described with reference to a flowchart of FIG. 14.

In step S141, the reference background update unit 27 controls the global motion estimation unit 81 so as to obtain a global motion as a motion vector V through block matching between pixels of the region excluding the object mask in the picked-up image and the reference background image. Then, the global motion estimation unit 81 supplies the obtained motion vector V to the motion compensation conversion unit 82. That is, the global motion indicates a magnitude of displacement which is caused by change, which occurs after the image pickup unit 21 picks up an image which is to be a reference background image, of one of panning, tilting, and zooming or change of a combination of panning, tilting, and zooming, and is obtained as the motion vector V in this example.

The global motion obtained as the motion vector V is obtained by a parameter which is used in affine-transforming the picked-up image and the reference background image with pixel values of the region excluding the region of the object mask in the picked-up image and the reference background image. In more specific, the motion vector V is obtained by a conversion formula which is used for the affine transform and is shown as formula (4) below.

$$( \begin{matrix}{x}_{i}^{′} \\ {y}_{i}^{′} \\ 0\end{matrix} ) = V ( \begin{matrix}{x}_{i} \\ {y}_{i} \\ 0\end{matrix} ) \qquad ( 4 )$$

Here, x′ᵢ and y′ᵢ are parameters expressing a pixel position (x′ᵢ, y′ᵢ) in the region excluding the object mask in the picked-up image, and i is an identifier for identifying each pixel. Further, xᵢ and yᵢ are parameters expressing a pixel position (xᵢ, yᵢ) in the region excluding the object mask in the reference background image. Here, the pixel (x′ᵢ, y′ᵢ) on the picked-up image and the pixel (xᵢ, yᵢ) on the reference background image have an identical identifier i, and the pixel (x′ᵢ, y′ᵢ) and the pixel (xᵢ, yᵢ) are pixels which are detected through block matching. The vector V is expressed by a determinant shown as formula (5) below.

$$V = ( \begin{matrix}{a}_{1} & {a}_{2} & {a}_{3} \\ {a}_{4} & {a}_{5} & {a}_{6} \\ 0 & 0 & 1\end{matrix} ) \qquad ( 5 )$$

Here, a₁ to a₆ are respectively coefficients.

That is, the global motion estimation unit 81 calculates the coefficients a₁ to a₆ by the least-square method with formula (4) based on the relationship between pixels detected through the block matching executed by using the pixels of the region excluding the object mask in the picked-up image and the reference background image. Through such the processing, the global motion estimation unit 81 obtains the motion vector V expressing displacement caused by displacement of the image pickup direction of the image pickup unit 21. In other words, the motion vector as the global motion showing the displacement is obtained by perform statistical processing with respect to a plurality of vectors of which starting points are set on respective pixels on the picked-up image and ending points are set on pixels, which are recognized to be identical to the pixels of the picked-up image through the block matching, on the reference background image.

In step S142, the motion compensation conversion unit 82 initializes a counter y expressing a vertical direction of the picked-up image to 0.

Hereafter, each pixel on the motion compensation update image is expressed as g(x, y), each pixel on the reference background image is expressed as f(x, y), and each pixel on the picked-up image is expressed as h(x, y). Further, the motion vector V on the pixel f(x, y) of the reference background image is defined as a motion vector V(vx, vy). Here, vx and vy are respectively obtained by formula (4) described above.

In step S143, the motion compensation conversion unit 82 initializes a counter x expressing a horizontal direction on the reference background image to 0.

In step S144, the motion compensation conversion unit 82 determines whether a pixel position (x-vx, y-vy) which is converted by a motion vector corresponding to the pixel f(x, y) of the reference background image is a coordinate existing within the reference background image.

When the pixel position which is converted exists within the reference background image in step S144, for example, the motion compensation conversion unit 82 substitutes the pixel g(x, y) of the motion compensation update image by the pixel f(x-vx, y-vy) of the reference background image in step S145.

On the other hand, when the pixel position which is converted does not exist in the reference background image in step S144, for example, the motion compensation conversion unit 82 substitutes the pixel g(x, y) of the motion compensation update image after the conversion by the pixel h(x, y) of the picked-up image in step S146.

The motion compensation conversion unit 82 increments the counter x by 1 in step S147, and the processing goes to step S148.

In step S148, the motion compensation conversion unit 82 determines whether the counter x has a larger value than the pixel number in the horizontal direction of the reference background image. In a case where the counter x does not have a larger value than the pixel number in the horizontal direction, the processing returns to step S144. That is, the processing from steps S144 to S148 are repeated until the counter x becomes to have a larger value than the pixel number in the horizontal direction of the reference background image in step S148.

Then, when the counter x becomes to have a larger value than the pixel number in the horizontal direction of the reference background image in step S148, the motion compensation conversion unit 82 increments the counter y by 1 in step S149. In step S150, the motion compensation conversion unit 82 determines whether the counter y is larger than the pixel number in the vertical direction of the reference background image. When the counter y is not larger than the pixel number, for example, the processing returns to step S143. That is, the processing from step S143 to step S150 are repeated until the counter y becomes larger than the pixel number in the vertical direction of the reference background image.

Then, when it is determined that the counter y is larger than the pixel number in the vertical direction of the reference background image in step S150, the motion compensation conversion unit 82 outputs a motion compensation update image composed of the pixel g(x, y) to the selection unit 83 in step S151. Then, the processing is ended.

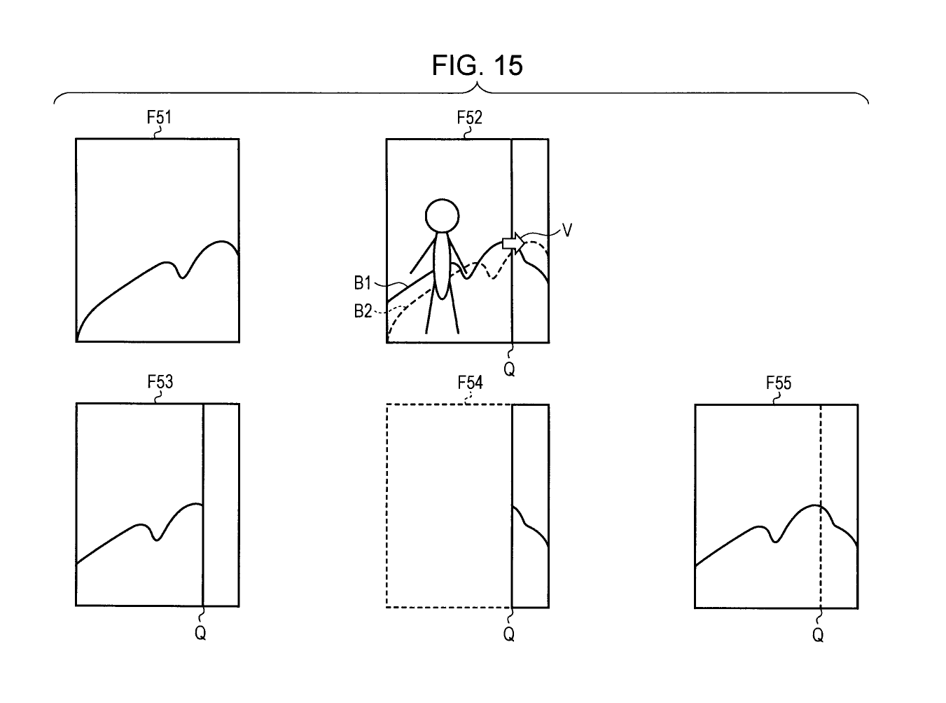

That is, concerning each pixel of the reference background image, a case where the pixel position which is converted exists within the reference background image in step S144 is a case where the pixel position is within a range of the left side of a position Q in the horizontal direction (a position on a right end of the reference background image) in an image F52 of FIG. 15, for example. In this case, the pixel which is converted exists in the original reference background image. Therefore, each pixel of the pixel g(x, y) of the motion compensation update image corresponding to the displacement is substituted by the pixel f(x-vx, y-vy) each of which is moved to the position corresponding to the motion vector V and converted as shown in an image F53 of FIG. 15.

On the other hand, concerning each pixel of the reference background image, a case where the pixel position which is converted does not exist within the reference background image in step S144 is a case where the pixel position is within a range of the right side of the position Q in the horizontal direction (a position on the right end of the reference background image) in the image F52 of FIG. 15, for example. In this case, the pixel which is converted does not exist in the original reference background image. Therefore, each pixel of the pixel g(x, y) of the motion compensation update image corresponding to the displacement is substituted by the pixel h(x, y), which is positioned on the corresponding position, of the picked-up image and converted as shown in an image F54 of FIG. 15.

These processing are executed to all pixels and therefore the motion compensation update image which corresponds to the displacement in the image pickup direction of the image pickup unit 21 and is shown in an image F55 of FIG. 15 is generated. That is, as shown in the image F52, a motion compensation update image F55 is obtained such that a mountain ridge line in a reference background image F51 (dotted line B2 in the image F55) caused by displacement of the image pickup direction corresponds to the picked-up image which is wholly shifted in the left direction as a ridge line B1 which is shown by a solid line.

Here, the description returns to the flowchart of FIG. 6.

In step S52, the reference background update unit 27 controls the selection unit 83 so as to allow the selection unit 83 to determine whether the failure type is a color failure or not. When the failure type is the color failure in step S52, for example, the selection unit 83 substitutes the reference background image stored in the background image storage unit 29 by the color conversion update image supplied from the color conversion unit 85 and thus updates the reference background image in step S53.

On the other hand, when the failure type is not the color failure, that is, when the failure type is a displacement failure in step S52, the selection unit 83 substitutes the reference background image stored in the background image storage unit 29 by the motion compensation conversion update image supplied from the motion compensation conversion unit 82 and thus updates the reference background image in step S54.

In the processing generating a background difference image which is generated by difference between the picked-up image and the reference background image, a color conversion update image can be generated with respect to a color failure which is caused by a change of a lighting condition or a color parameter of the picked-up image and thereby the reference background image can be updated through the above-described processing. Further, a motion compensation update image can be generated with respect to displacement failure which is caused by displacement of the image pickup direction of the picked-up image and thereby the reference background image can be updated. Furthermore, a failure type such as a color failure and a displacement failure can be identified. As a result, the reference background image can be updated in a manner to correspond to a type of a failure, so that an object constituting a foreground can be exclusively extracted in high accuracy by generating a background difference image.

By the way, the series of the processing described above may be performed either by hardware or software. In a case where the series of processing is performed by software, a program constituting the software is installed from a storage medium into a computer incorporated in dedicated hardware or into a general-purpose personal computer, for example, which is capable of performing various functions when various programs are installed.

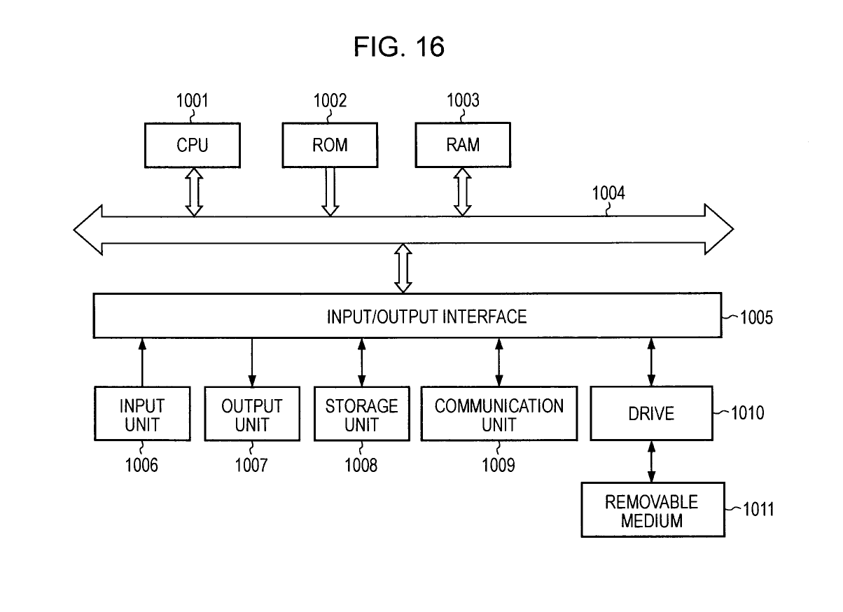

FIG. 16 illustrates a configuration example of a general-purpose personal computer. This personal computer includes a central processing unit (CPU) 1001. To the CPU 1001, an input/output interface 1005 is connected via a bus 1004. To the bus 1004, a read only memory (ROM) 1002 and a random access memory (RAM) 1003 are connected.

To the input/output interface 1005, an input unit 1006, an output unit 1007, a storage unit 1008, and a communication unit 1009 are connected. The input unit 1006 is composed of an input device such as a key board and a mouse with which a user inputs an operational command. The output unit 1007 outputs a processing operational screen and an image of a processing result to a display device. The storage unit 1008 is composed of a hard disk drive which stores a program and various kinds of data and the like. The communication unit 1009 is composed of a local area network (LAN) adapter and the like, and executes communication processing through the network typified by internet. Further, a drive 1010 is connected to the input/output interface 1005. The drive 1010 reads and writes data from and to a removable medium 1011 which is a magnetic disc (including a flexible disc), an optical disc (including compact disc-read only memory (CD-ROM) and a digital versatile disc (DVD)), a magnetic-optical disc (including a mini disc (MD)), or a semiconductor memory.

The CPU 1001 executes various kinds of processing in accordance with a program stored in the ROM 1002 or a program which is read from the removable medium 1011, which is a magnetic disc, an optical disc, a magnetic-optical disc, or a semiconductor memory, for example, installed in the storage unit 1008, and loaded on the RAM 1003 from the storage unit 1008. The RAM 1003 arbitrarily stores data which is necessary when the CPU 1001 executes various kinds of processing.

It should be noted that steps for describing a program which is to be stored in a storage medium include processing which is executed in a time-series manner corresponding to the described order of this specification, and also include processing which is not necessarily executed in a time-series manner, that is, the processing which is executed in a parallel manner or an individual manner.

Further, in this specification, the system indicates the whole device which is constituted by a plurality of devices.

The present application contains subject matter related to that disclosed in Japanese Priority Patent Application JP 2010-079184 filed in the Japan Patent Office on Mar. 30, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device, comprising:
a reference background storage means for storing a reference background image;
an estimation means for detecting an object from an input image and estimating an approximate position and an approximate shape of the object that is detected;
a background difference image generation means for generating a background difference image obtained based on a difference value between the input image and the reference background image;
a failure determination means for determining whether a failure occurs in the background difference image based on a comparison between the background difference image that is generated by the background difference image generation means and the object that is estimated by the estimation means;
a failure type identification means for identifying a type of the failure; and
a background image update means for updating the reference background image in a manner to correspond to the type of the failure.

2. The image processing device according to claim 1, wherein the failure determination means compares the object to the background difference image so as to determine whether the failure occurs based on whether a ratio of a region of the background difference image with respect to a region of the object is larger than a predetermined ratio.

3. The image processing device according to claim 1, further comprising:
a change amount calculation means for calculating a change amount between pixels, the pixels corresponding to each other, in regions excluding region of the object, the object being estimated by the estimation means, of the reference background image and the background difference image; wherein
in a case where the change amount is larger than a predetermined value, the failure type identification means identifies a failure type as a color failure based on a color change, and in a case where the change amount is free from being larger than the predetermined value, the failure type identification means identifies the failure type as a displacement failure based on displacement of an image pickup direction of the input image.

4. The image processing device according to claim 3, further comprising:
a motion vector calculation means for comparing the input image and the reference background image so as to obtain displacement of the image pickup direction of the input image as a motion vector;
a motion compensation means for performing motion compensation with respect to the reference background image based on the motion vector so as to generate a motion compensation background image;
a calculation means for calculating a relational formula of pixel values between pixels, the pixels corresponding to each other, in the reference background image and the region excluding the region of the object, the object being estimated by the estimation means, in the background difference image; and
a conversion means for converting the pixel value of the reference background image based on the relational formula so as to generate a pixel value conversion background image; wherein
when the failure type identified by the failure type identification means is the displacement failure, the background image update means substitutes the reference background image with the motion compensation background image so as to update the reference background image, and
when the failure type identified by the failure type identification means is the color failure, the background image update means substitutes the reference background image with the pixel value conversion background image so as to update the reference background image.

5. The image processing device according to claim 4, wherein when the failure determination means determines that there is no occurrence of a failure, the background image update means keeps the reference background image as it is.

6. The image processing device according to claim 4, wherein the motion vector calculation means compares the region excluding the region of the object in the reference background image to the region excluding the region of the object in the input image so as to obtain a motion vector by which a sum of difference absolute values between corresponding pixels of the images becomes the minimum.

7. The image processing device according to claim 1, wherein an object detection means includes a person detection means for detecting a person as an object, an animal detection means for detecting an animal as an object, and a vehicle detection means for detecting a vehicle as an object.

8. The image processing device according to claim 7, wherein the person detection means includes a face detection means for detecting a face image of the person from the input image, and a body mask estimation means for estimating a body mask from a position and a size in which a body of the person, the body of the person being estimated based on the face image that is detected by the face detection means, exists.

9. An image processing method of an image processing device, the image processing device including,
a reference background storage means for storing a reference background image,
an estimation means for detecting an object from an input image and estimating an approximate position and an approximate shape of the object that is detected,
a background difference image generation means for generating a background difference image obtained based on a difference value between the input image and the reference background image,
a failure determination means for determining whether a failure occurs in the background difference image based on a comparison between the background difference image that is generated by the background difference image generation means and the object that is estimated by the estimation means,
a failure type identification means for identifying a type of the failure, and
a background image update means for updating the reference background image in a manner to correspond to the type of the failure, the image processing method comprising the steps of:
storing the reference background image, in the reference background storage means;
detecting the object from the input image and estimating the approximate position and the approximate shape of the object that is detected, in the estimation means;
generating the background difference image based on the difference value between the input image and the reference background image, in the background difference image generation means;
determining whether a failure occurs in the background difference image based on the comparison between the background difference image that is generated through processing of the step of generating a background difference image and the object that is estimated through processing of the step of estimating, in the failure determination means;
identifying a type of the failure, in the failure type identification means; and
updating the reference background image in a manner to correspond to the type of the failure, in the background image update means.

10. A program allowing a computer that controls an image processing device, the image processing device including
a reference background storage means for storing a reference background image,
an estimation means for detecting an object from an input image and estimating an approximate position and an approximate shape of the object that is detected,
a background difference image generation means for generating a background difference image obtained based on a difference value between the input image and the reference background image,
a failure determination means for determining whether a failure occurs in the background difference image based on a comparison between the background difference image that is generated by the background difference image generation means and the object that is estimated by the estimation means,
a failure type identification means for identifying a type of the failure, and
a background image update means for updating the reference background image in a manner to correspond to the type of the failure, the program allowing the computer to execute processing comprising the steps of:
storing the reference background image, in the reference background storage means;
detecting the object from the input image and estimating the approximate position and the approximate shape of the object that is detected, in the estimation means;
generating the background difference image based on the difference value between the input image and the reference background image, in the background difference image generation means;
determining whether a failure occurs in the background difference image based on the comparison between the background difference image that is generated through processing of the step of generating a background difference image and the object that is estimated through processing of the step of estimating, in the failure determination means;
identifying a type of the failure, in the failure type identification means; and
updating the reference background image in a manner to correspond to the type of the failure, in the background image update means.

11. An image processing device, comprising:
a reference background storage unit configured to store a reference background image;
an estimation unit configured to detect an object from an input image and estimate an approximate position and an approximate shape of the object that is detected;
a background difference image generation unit configured to generate a background difference image obtained based on a difference value between the input image and the reference background image;
a failure determination unit configured to determine whether a failure occurs in the background difference image based on a comparison between the background difference image that is generated by the background difference image generation unit and the object that is estimated by the estimation unit;
a failure type identification unit configured to identify a type of the failure; and
a background image update unit configured to update the reference background image in a manner to correspond to the type of the failure.
